(19) United States
(12) Patent Application Publication
(10) Pub. No.: US 2023/0008305 A1
(43) Pub. Date: Jan. 12, 2023

(54) SYSTEM AND METHOD THEREOF FOR EFFICIENT PRODUCTION OF AMMONIA

(71) Applicants: SAGEL, Karmiel (IL); T -Tie Ltd., Jerusalem (IL)

(72) Inventors: Alexander SERGIENKO, Karmiel (IL); Michael Yehuda ENDE, Moshav Shueva (IL)

(73) Assignees: SAGEL, Karmiel (IL); T -Tie Ltd., Jerusalem (IL)

(21) Appl. No.: 17/932,877

(22) Filed: Sep. 16, 2022

Related U.S. Application Data
(63) Continuation of application No. PCT/IB2021/052170, filed on Mar. 16, 2021.
(60) Provisional application No. 62/990,036, filed on Mar. 16, 2020.

(51) Int. Cl. C01C 1/02; C01C 1/12

(52) U.S. Cl. CPC C01C 1/028; C01C 1/12

(57) ABSTRACT

A system and method for production of ammonia are presented. The system includes a reactor adapted to receive therein through a first input of the reactor sulfate ammonia and a reacting agent through a second input of the reactor, wherein the reactor is heated to a temperature not to exceed a predetermined temperature to create a chemical reaction between a sulfate ammonia and the reacting agent; and a purifier adapted to accept ammonia from the reactor and perform a purification process to purify the ammonia to a predetermined degree of purification.

### CROSS-REFERENCE TO RELATED APPLICATIONS

This application is continuation of International Application No. PCT/IB2021/052170 filed on Mar. 16, 2021, now pending, which claims the benefit of U.S. Provisional Patent Application No. 62/990,036 filed on Mar. 16, 2020. The contents of the above-referenced applications are hereby incorporated by reference.

### TECHNICAL FIELD

This invention relates to a manufacturing technology for the production of ammonia (NH3), and more specifically for the recovery of ammonia from ammonia sulfate.

### BACKGROUND

Ammonium sulfate is an important chemical in the fertilizer industry. Liquors containing ammonium sulfate are obtained as byproducts of various manufacturing processes, and are typically utilized for the production of fertilizers. In some geographic regions, an ammonium sulfate byproduct from a chemical process can be sold as fertilizer. In other regions, where ammonium sulfate fertilizer usage is limited, excess ammonium sulfate must be disposed of.

A great quantity of ammonium sulfate is formed in various industries. One example is the chemical industry involving treatment of an ammoxidation product of organic matter with sulfuric acid (such as the production of epsilon-caprolactam, methyl methacrylate by the acetone cyanohydrin method, and acrylonitrile by the ethylene cyanohydrin method). Another industry is one where liquor resulting from ammonia neutralization of desulfurization waste liquor formed by treatment of crude oil with sulfuric acid is discharged. Yet another is an industry where desulfurization of exhaust gases is carried out by using aqueous ammonia. This ammonium sulfate is used mainly as a fertilizer. Typically there is excess supply over demand of ammonium sulfate.

In the related art, there are two methods of realizing the above mentioned aims. One method is to link the acid ion to a stronger base, e.g., iron oxide, thereby forming a stable salt which permits the ammonia to be driven off. According to another method, discussed in the related art, the ammonium ion is converted into a stable salt, e.g., by combination with phosphoric acid, whereby sulfur trioxide is set free. Each of these processes requires a second step in which the combined ion has to be recovered, for instance, by thermic decomposition. The intermediary production of a metal sulfate from which sulfur trioxide is obtained by thermic decomposition has obvious technical difficulties and is faced with the disadvantage that the splitting operations for NH3 and SO3 cannot be properly kept separate. In other words, pure products cannot be obtained at technically feasible reaction conditions.

About ninety percent of ammonium sulfate is produced by three different processes: (1) as a byproduct of caprolactam [(CH2)5COHN] production; (2) from synthetic manufacture; and, (3) as a coke oven byproduct. The remainder is produced as a byproduct of either nickel or methyl methacrylate manufacture, or from ammonia scrubbing of tailgas at sulfuric acid (H2SO4) plants. Ammonium sulfate is produced as a byproduct from the caprolactam oxidation process stream and the rearrangement reaction stream. Coke oven byproduct ammonium sulfate is produced by a reaction of the ammonia recovered from coke oven off gas with sulfuric acid.

Further, a considerable amount of ammonia is required for neutralizing the sulfuric acid that remains in the waste liquor, which in turn is a significant burden. Moreover, since ammonium sulfate contains impurities, much work is needed for its purification to a level suitable for use. Thus, in the industries where ammonium sulfate occurs, it is an important problem to recover it in an economically feasible form.

Therefore, it would be advantageous to provide a solution that overcome the deficiencies noted above.

### SUMMARY

A summary of several examples embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The disclosed embodiments include a system for production of ammonia. The system comprising: a reactor adapted to receive therein through a first input of the reactor sulfate ammonia and a reacting agent through a second input of the reactor, wherein the reactor is heated to a temperature not to exceed a predetermined temperature to create a chemical reaction between a sulfate ammonia and the reacting agent; and a purifier adapted to accept ammonia from the reactor and perform a purification process to purify the ammonia to a predetermined degree of purification.

The disclosed embodiments also include a method for producing ammonia. The method includes providing sulfate ammonia and a reacting agent to a reactor; heating the reactor to a predetermined temperature to create a chemical reaction between the sulfate ammonia and the reacting agent; providing the ammonia produced in the reactor to an ammonia purifier; and purifying the ammonia to a predetermined level of purity.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram of a system for production of ammonia according to an embodiment.

FIG. 2 is a flowchart of an operation flow of the system, of FIG. 1, for efficient production of ammonia according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claims. Moreover, some statements may apply to some inventive features but not to others. In general, unless otherwise indicated, singular elements may be in plural and vice versa with no loss of generality.

According to an example embodiment, a method of manufacture results in efficient production of ammonia (NH3) and byproducts such as Na2SO4, HCL, CaSO4, ZnSO4, Al2SO4, K2SO4 and the like. These are produced with good purity by decomposing of ammonium sulfate under relatively mild operating conditions. The ammonium sulfate reacts with a metal oxide or hydroxide at a temperature of not more than 250° C. to form NH3 and a metal sulfate. An advantage of the methods of manufacture is that it makes it possible to provide ammonia production safely and on a continuous amount on an as needed basis, as well as mobile manufacturing units.

The term ammonium sulfate as used herein refers to starting materials that are not only to ammonium sulfate itself but also to acid ammonium sulfate, acid ammonium sulfate containing sulfuric acid, and any mixtures thereof. In one embodiment these starting materials may include impurities in a concentration of up to 10% by weight. The impurities include, for example but not by way of limitation, non-combustible carbon, ash, epsilon-caprolactam, acetonedisulfonic acid, p-toluenesulfonic acid, polymers of these and sulfur which are contained in an epsilon-caprolactam waste liquor, methyl methacrylate waste liquor from an acetone-cyanohydrin process, acrylonitrile waste liquor from ethylene-cyanohydrin process and crude oil refining waste liquor.

There are various different reactions that may be performed according to the invention. These include, but are not limited to, the following chemical reactions which would be understood by one of ordinary skill:

(NH4)2SO4+2NaOH→Na2SO4+2NH3+2H2O

In an example case (a), in a reactor there are mixed ammonium sulfate and sodium hydroxide, for example in the presence of water. The mix is heated to no more than 250° C., preferably in the range of 70 to 100° C. As a result of the chemical interaction, the resultant compounds are produced: sodium sulfate, ammonia, and water. Another reaction may be:

(NH4)2SO4+2KOH→K2SO4+2NH3+2H2O

In another example case (b), in a reactor there are mixed ammonium sulfate and potassium hydroxide, for example in the presence of water. The mix is heated to no more than 250° C., preferably in the range of 70 to 100° C. As a result of the chemical interaction, the resultant compounds are produced: potassium sulfate, ammonia, and water. Yet another reaction may be:

2(NH4)2SO4+2KOH+2NaOH→2Na2SO4+2K2SO4+4NH3+2H2O

In another example case (c), in a reactor there are mixed ammonium sulfate, potassium hydroxide and sodium hydroxide, for example in the presence of water. The mix is heated to no more than 250° C., preferably in the range of 70 to 100° C. As a result of the chemical interaction, the resultant compounds are produced: sodium sulfate, potassium sulfate, ammonia, and water. Yet another reaction may be:

(NH4)2SO4+2NaCl→Na2SO4+2NH3+2HCl

In another example case (d), in a reactor there are mixed ammonium sulfate and sodium chloride (commonly known as salt), for example in the presence of water. The mix is heated to no more than 250° C., preferably in the range of 70 to 100° C. As a result of the chemical interaction, the resultant compounds are produced: potassium sulfate, ammonia, and hydrogen chloride, when solved in water also known as hydrochloric acid. Yet another reaction may be:

(NH4)2SO4+Ca(OH)2→CaSO4+2NH3+2H2O

In another example case (e), in a reactor there are mixed ammonium sulfate and calcium hydroxide, for example in the presence of water. The mix is heated to no more than 250° C., preferably in the range of 70 to 100° C. As a result of the chemical interaction, the resultant compounds are produced: calcium sulfate, ammonia, and water. Yet another reaction may be:

(NH4)2SO4+2Na(Al(OH)4)→2Al(OH)3+Na2SO4+2NH3+4H2O

In another example case (f), in a reactor there are mixed ammonium sulfate and sodium (meta) aluminate, for example in the presence of water. The mix is heated to no more than 250° C., preferably in the range of 70 to 100° C. As a result of the chemical interaction, the resultant compounds are produced: aluminum hydroxide, sodium sulfate, ammonia, and water.

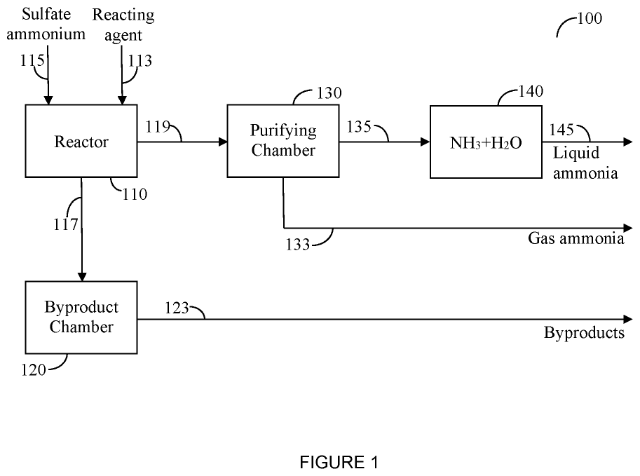

FIG. 1 depicts a schematic diagram of a system 100 for efficient production of ammonia according to an embodiment. The system includes a reactor 110. At input 115 the reactor is adapted to receive sulfate ammonium and at input 113 it receives a metal oxide or hydroxide substance as described herein.

In one embodiment the reactor further contains therein also an amount of water (H2O). The reactor is heated to a temperature not to exceed 250° C., preferably in the range of 70 to 100° C. As a result, a chemical interaction occurs resulting in the chemical response as described herein which includes the output 117 to provide the ammonia purifier chamber 130. Another out 119 of reactor 110 provides to a byproduct collection chamber 120 from which by-products produced by the process as described herein may be collected and provided through output 123. In one embodiment, the byproduct collection chamber 120 may be used for decomposing the metal sulfate in the presence of a reducing agent to form a metal oxide and SO2.

The ammonia purifier chamber 130 is adapted to perform purification of the ammonia extracted by the process described herein. The ammonia purifier chamber 130 may provide ammonia as a gas through output 133 or through output 135 to a mixing chamber where the ammonia is mixed with water to provide liquid ammonia on output 145 of the mixing chamber 140. One of ordinary skill in the art would readily realize the advantages of the described system when compared to the prior art solution. Firstly, the temperatures used by the reactor 110 do not exceed 250° C., preferably in the range of 70 to 100° C., which reduces costs and is inherently safer.

Secondly, the input substances used to produce the ammonia are safe and until the production of the ammonia itself do not pose an inherent safety threat. Thirdly, the system 100 is a simple system that can produce efficiently ammonia in small quantities, on-location thereby enabling the production of ammonia on premise rather than by using large-scale manufacturing structures that, while efficient (but not more efficient than the described process herein), require the storage and transportation of relatively large quantities of ammonia thereby posing a safety hazard.

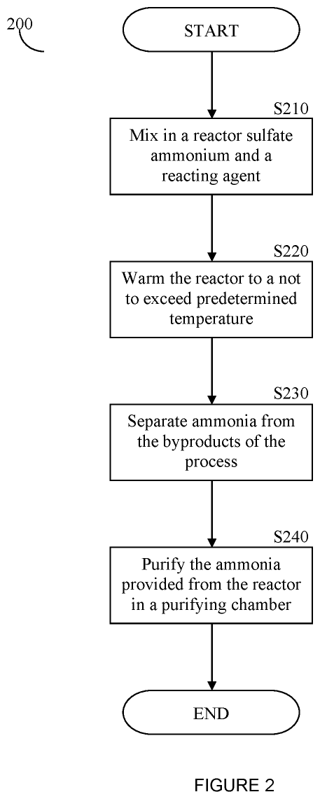

FIG. 2 describes an example flowchart 200 of an operation flow of the system 100 for efficient production of ammonia according to an embodiment. At S210 ammonium sulfate is reacted, for example in reactor 110, with the metal oxide or hydroxide. Generally, but not by way of limitation, the use of an oxide or hydroxide of a metal is selected from Ca, Na, K, Al, Fe, Zn, Cu, and like elements, and is preferred because it produces the desired effects described herein and are practicable. In an embodiment the reaction takes place in a medium such as water (H2O).

At S220 the solution is heated, for example in reactor 110, to a temperature not to exceed 250° C., and more preferably in the range of 70 to 100° C. At S230 separation of the ammonia from the byproducts takes place, for example by clearing the byproducts from the reactor 110 through output 119, and clearing the ammonia from the reactor 110 through output 107. In S240 the ammonia provided by the reaction is purified in, for example, an ammonia purification chamber 130 from which ammonia in the form of gas or in the form of liquid, i.e., ammonia and water, is provided.

In one embodiment, the system 100 is adapted to small production scale units. This allows the implementation of modular compact factories for the production of ammonia and secondary products. Moreover, this can be also produced as mobile version. These small units, due to the recovery processes discussed herein result in economically profitable solutions which are safe in the transportation and storage of ammonia compared to existing prior art solutions.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A system for production of ammonia, comprising:
a reactor adapted to receive therein through a first input of the reactor sulfate ammonia and a reacting agent through a second input of the reactor, wherein the reactor is heated to a temperature not to exceed a predetermined temperature to create a chemical reaction between a sulfate ammonia and the reacting agent; and
a purifier adapted to accept ammonia from the reactor and perform a purification process to purify the ammonia to a predetermined degree of purification.

2. The system of claim 1, wherein the reacting agent is any one of: a metal oxide and a hydroxide.

3. The system of claim 2, wherein the metal oxide is NaCl.

4. The system of claim 2, wherein the hydroxide is at least one of: NaOH, KOH, Ca(OH)2, and Na(Al(OH)4).

5. The system of claim 1, wherein the predetermined temperature is 250° C.

6. The system of claim 1, wherein the temperature is in the range of 70° C. to 100° C.

7. The system of claim 1, wherein the reactor further contains therein water (H2O).

8. The system of claim 1, wherein the chemical reaction is one any of:
(NH4)2SO4+2NaOH→Na2SO4+2NH3+2H2O;
(NH4)2SO4+2KOH→K2SO4+2NH3+2H2O;
2(NH4)2SO4+2KOH+2NaOH→2Na2SO4+2K2SO4+4NH3+2H2O;
(NH4)2SO4+2NaCl→Na2SO4+2NH3+2HCl;
(NH4)2SO4+Ca(OH)2→CaSO4+2NH3+2H2O; and
(NH4)2SO4+2Na(Al(OH)4)→2l1(OH)3+Na2SO4+2NH3+4H2O.

9. The system of claim 1, wherein the system is a mobile manufacturing unit.

10. The system of claim 1, wherein the system is further adapted to provide at least one of: gas ammonia, and liquid ammonia.

11. A method for producing ammonia, comprising:
providing sulfate ammonia and a reacting agent to a reactor;
heating the reactor to a predetermined temperature to create a chemical reaction between the sulfate ammonia and the reacting agent;
providing the ammonia produced in the reactor to an ammonia purifier; and
purifying the ammonia to a predetermined level of purity.

12. The method of claim 11, wherein the reacting agent is any one of: a metal oxide and a hydroxide.

13. The method of claim 12, wherein the metal oxide is NaCl.

14. The method of claim 12, wherein the hydroxide is at least one of: NaOH, KOH, Ca(OH)2, and Na(Al(OH)4).

15. The method of claim 11, wherein the predetermined temperature is 250° C.

16. The method of claim 11, wherein the temperature is in the range of 70° C. to 100° C.

17. The method of claim 11, further comprising:
adding water (H2O) to the reactor.

18. The method of claim 11, wherein the chemical reaction is any one of:
(NH4)2SO4+2NaOH→Na2SO4+2NH3+2H2O;
(NH4)2SO4+2KOH→K2SO4+2NH3+2H2O;
2(NH4)2SO4+2KOH+2NaOH→2Na2SO4+2K2SO4+4NH3+2H2O;
(NH4)2SO4+2NaCl→Na2SO4+2NH3+2HCl;
(NH4)2SO4+Ca(OH)2→CaSO4+2NH3+2H2O; and
(NH4)2SO4+2Na(Al(OH)4)→2l1(OH)3+Na2SO4+2NH3+4H2O.

19. The method of claim 11, further comprising: providing gas ammonia.

20. The method of claim 11, further comprising: providing liquid ammonia.
